(19) United States
(12) Patent Application Publication
(10) Pub. No.: US 2025/0330232 A1
(43) Pub. Date: Oct. 23, 2025

(54) APPARATUS, SYSTEM, AND METHOD OF COMMUNICATING A PACKET INCLUDING A MULTIPLE-INPUT-MULTIPLE-OUTPUT (MIMO) TRAINING (TRN) FIELD

(71) Applicant: INTEL CORPORATION, Santa Clara, CA (US)

(72) Inventors: Laurent Cariou, Milizac (FR); Thomas J. Kenney, Portland, OR (US)

(73) Assignee: INTEL CORPORATION, Santa Clara, CA (US)

(21) Appl. No.: 18/870,650

(22) PCT Filed: Jun. 30, 2022
(86) PCT No.: PCT/US2022/035635

§ 371 Date: Nov. 30, 2024

(51) Int. Cl. H04B 7/08; H04B 7/06; H04L 25/03; H04L 27/26

(52) U.S. Cl. CPC H04B 7/088; H04B 7/06952; H04L 25/03; H04L 27/26132; H04L 2025/03815

(57) ABSTRACT

For example, a millimeterWave (mmWave) wireless communication station (STA) may be configured to transmit a preamble of a packet via a plurality of antennas of the mmWave STA over a mmWave wireless communication channel; and to transmit a Multiple-Input-Multiple-Output (MIMO) Training (TRN) field of the packet over the mmWave wireless communication channel, the MIMO TRN field is after the preamble, the MIMO TRN field including a sequence of a plurality of MIMO TRN subfields transmitted via the plurality of antennas of the mmWave STA. For example, a MIMO TRN subfield of the plurality of MIMO TRN subfields may include a plurality of TRN sequences simultaneously transmitted via the plurality of antennas, respectively.

### TECHNICAL FIELD

Aspects described herein generally relate to communicating a packet including a Multiple-Input-Multiple-Output (MIMO) Training (TRN) field.

### BACKGROUND

Devices in a wireless communication system may be configured to communicate over a millimeterWave (mmWave) wireless communication channel. There is a need to provide a technical solution to support beamforming communications over the mmWave wireless communication channel.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a multi-link communication scheme, which may be implemented in accordance with some demonstrative aspects.

FIG. 3 is a schematic illustration of a multi-link communication scheme, which may be implemented in accordance with some demonstrative aspects.

FIG. 4 is a schematic illustration of a beamforming training procedure over a millimeterWave (mmWave) wireless communication channel, in accordance with some demonstrative aspects.

FIG. 5 is a schematic illustration of a packet, in accordance with some demonstrative aspects.

FIG. 6 is a schematic flow-chart illustration of a method of communicating a packet including a Multiple-Input-Multiple-Output (MIMO) Training (TRN) field, in accordance with some demonstrative aspects.

FIG. 7 is a schematic flow-chart illustration of a method of communicating a packet including a MIMO TRN field, in accordance with some demonstrative aspects.

FIG. 8 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December 2020); and/or IEEE 802.11be (IEEE P802.11be/D1.5 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), March 2022)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by a mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHZ, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

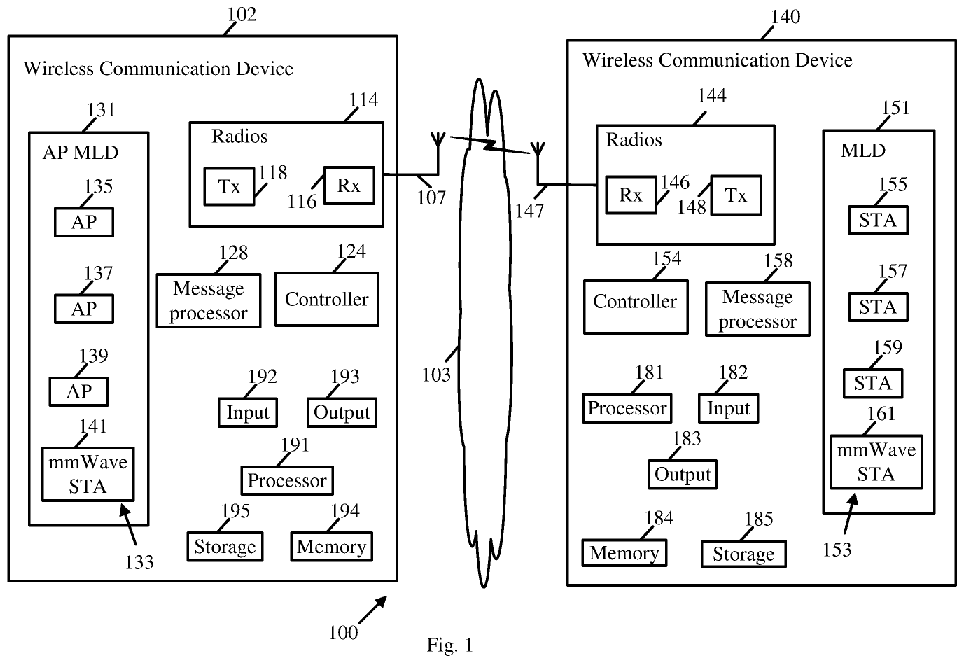

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, and/or one or more other devices.

In some demonstrative aspects, devices 102 and/or 140 may include a mobile device or a non-mobile, e.g., a static, device.

For example, devices 102, and/or 140 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102 and/or 140 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, one or more channels in a 2.4 GHz wireless communication frequency band, one or more channels in a 5 GHz wireless communication frequency band, and/or one or more channels in a 6 GHz wireless communication frequency band. For example, WM 103 may additionally or alternatively include one or more channels in a mmWave wireless communication frequency band.

In other aspects, WM 103 may include any other type of channel over any other frequency band.

In some demonstrative aspects, device 102 and/or device 140 may include one or more radios including circuitry and/or logic to perform wireless communication between devices 102, 140, and/or one or more other wireless communication devices. For example, device 102 may include one or more radios 114, and/or device 140 may include one or more radios 144.

In some demonstrative aspects, radios 114 and/or 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a sub-10 Ghz band, for example, 2.4 GHz band, a 5 GHz band, a 6 GHz band, and/or any other sub-10 GHz band; and/or an mmWave band, e.g., a 45 Ghz band, a 60 Ghz band, and/or any other mmWave band; and/or any other band, e.g., a 5G band, an S1G band, and/or any other band.

In some demonstrative aspects, radios 114 and/or 144 may include, or may be associated with one or more, e.g., a plurality of, antennas.

In some demonstrative aspects, device 102 may include one or more, e.g., a plurality of, antennas 107, and/or device 140 may include one or more, e.g., a plurality of, antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or the one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102 and/or device 140 may include, operate as, perform the role of, and/or perform one or more functionalities of, one or more STAs. For example, device 102 may include at least one STA, and/or device 140 may include at least one STA.

In some demonstrative aspects, device 102 and/or device 140 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, device 102 and/or device 140 may include, operate as, perform the role of, and/or perform one or more functionalities of, one or more mmWave STAs, e.g., DMG STAs, EDMG STAs, and/or any other mmWave STA. For example, device 102 may include, operate as, perform the role of, and/or perform one or more functionalities of, one or more mmWave STAs, and/or device 140 may include, operate as, perform the role of, and/or perform one or more functionalities of, one or more mmWave STAs.

In other aspects, devices 102, and/or 140 may include, operate as, perform the role of, and/or perform one or more functionalities of, any other wireless device and/or station, e.g., a WLAN STA, a WiFi STA, and the like.

In some demonstrative aspects, device 102 and/or device 140 may be configured to operate as, perform the role of, and/or perform one or more functionalities of, an access point (AP), e.g., an EHT AP STA.

In some demonstrative aspects, device 102 and/or device 140 may be configured to operate as, perform the role of, and/or perform one or more functionalities of, a non-AP STA, e.g., an EHT non-AP STA.

In other aspects, device 102 and/or device 140 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102 and/or 140 may be configured to communicate in an EHT network, and/or any other network.

In some demonstrative aspects, devices 102 and/or 140 may be configured to operate in accordance with one or more Specifications, for example, including one or more IEEE 802.11 Specifications, e.g., an IEEE 802.11-2020 Specification, an IEEE 802.11be Specification, an IEEE 802.11ay Specification and/or any other specification and/or protocol.

In some demonstrative aspects, device 102 and/or device 140 may include, operate as, perform a role of, and/or perform the functionality of, one or more multi-link logical entities, e.g., as described below.

In other aspect, device 102 and/or device 140 may include, operate as, perform a role of, and/or perform the functionality of, any other entities, e.g., which are not multi-link logical entities.

For example, a multi-link logical entity may include a logical entity that contains one or more STAs. The logical entity may have one MAC data service interface and primitives to the logical link control (LLC) and a single address associated with the interface, which can be used to communicate on a distribution system medium (DSM). For example, the DSM may include a medium or set of media used by a distribution system (DS) for communications between APs, mesh gates, and the portal of an extended service set (ESS). For example, the DS may include a system used to interconnect a set service of basic sets (BSSs) and integrated local area networks (LANs) to create an extended service set (ESS). In one example, a multi-link logical entity may allow STAs within the multi-link logical entity to have the same MAC address. The multi-link entity may perform any other additional or alternative functionality.

In some demonstrative aspects, device 102 and/or device 140 may include, operate as, perform a role of, and/or perform the functionality of, a Multi-Link Device (MLD). For example, device 102 may include, operate as, perform a role of, and/or perform the functionality of, at least one MLD, and/or device 140 may include, operate as, perform a role of, and/or perform the functionality of, at least one MLD, e.g., as described below.

For example, an MLD may include a device that is a logical entity and has more than one affiliated STA and has a single MAC service access point (SAP) to LLC, which includes one MAC data service. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102 and/or device 140 may be configured to operate as, perform the role of, and/or perform one or more functionalities of, an AP MLD.

In some demonstrative aspects, device 102 and/or device 140 may be configured to operate as, perform the role of, and/or perform one or more functionalities of, a non-AP MLD.

In other aspects, device 102 and/or device 140 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In one example, a multi-link infrastructure framework may be configured as an extension from a one link operation between two STAs, e.g., an AP and a non-AP STA.

In some demonstrative aspects, controller 124 may be configured to control, perform and/or to trigger, cause, instruct and/or control device 102 to operate as, perform a role of, and/or perform one or more operations and/or functionalities of, an AP MLD 131 including a plurality of STAs 133, e.g., including an AP STA 135, an AP STA 137, an AP STA 139, and/or an mmWave STA 141. In some aspects, as shown in FIG. 1, AP MLD 131 may include four STAs. In other aspects, AP MLD 131 may include any other number of STAs.

In one example, AP STA 135, AP STA 137, AP STA 139, and/or mmWave STA 141 may operate as, perform a role of, and/or perform one or more operations and/or functionalities of, an EHT AP STA. In other aspects, AP STA 135, AP STA 137, AP STA 139, and/or mmWave STA 141 may perform any other additional or alternative functionality.

In some demonstrative aspects, mmWave STA 141 may operate as, perform a role of, and/or perform one or more operations and/or functionalities of, a mmWave AP STA. In other aspects, mmWave STA 141 may operate as, perform a role of, and/or perform one or more operations and/or functionalities of an mmWave network controller to control communication over an mmWave wireless communication network.

In some demonstrative aspects, for example, the one or more radios 114 may include, for example, a radio for communication by AP STA 135 over a first wireless communication frequency channel and/or frequency band, e.g., a 2.4 Ghz band, as described below.

In some demonstrative aspects, for example, the one or more radios 114 may include, for example, a radio for communication by AP STA 137 over a second wireless communication frequency channel and/or frequency band, e.g., a 5 Ghz band, as described below.

In some demonstrative aspects, for example, the one or more radios 114 may include, for example, a radio for communication by AP STA 139 over a third wireless communication frequency channel and/or frequency band, e.g., a 6 Ghz band, as described below.

In some demonstrative aspects, for example, the one or more radios 114 may include, for example, a radio for communication by mmWave STA 141 over a fourth wireless communication frequency channel and/or frequency band, e.g., an mmWave band, for example, a wireless communication band above 45 Ghz, for example, a 60 GHz band or any other mmWave band, e.g., as described below.

In some demonstrative aspects, the radios 114 utilized by STAs 133 may be implemented as separate radios. In other aspects, the radios 114 utilized by STAs 133 may be implemented by one or more shared and/or common radios and/or radio components.

In other aspects controller 124 may be configured to control, perform and/or to trigger, cause, instruct and/or control device 102 to operate as, perform a role of, and/or perform one or more operations and/or functionalities of, any other additional or alternative entity and/or STA, e.g., a single STA, multiple STAs, and/or a non-MLD entity.

In some demonstrative aspects, controller 154 may be configured to control, perform and/or to trigger, cause, instruct and/or control device 140 to operate as, perform a role of, and/or perform one or more operations and/or functionalities of, an MLD 151 including a plurality of STAs 153, e.g., including a STA 155, a STA 157, a STA 159, and/or a STA 161. In some aspects, as shown in FIG. 1, MLD 151 may include four STAs. In other aspects, MLD 151 may include any other number of STAs.

In one example, STA 155, STA 157, STA 159, and/or STA 161 may operate as, perform a role of, and/or perform one or more operations and/or functionalities of, an EHT STA. In other aspects, STA 155, STA 157, STA 159, and/or STA 161 may perform any other additional or alternative functionality.

In some demonstrative aspects, STA 161 may be configured to operate as, perform a role of, and/or perform one or more operations and/or functionalities of, an mmWave STA, e.g., as described below. For example, the mmWave STA 161 may be configured to operate as, perform a role of, and/or perform one or more operations and/or functionalities of, a non-AP mmWave STA, e.g., as described below.

In some demonstrative aspects, for example, the one or more radios 144 may include, for example, a radio for communication by STA 155 over a first wireless communication frequency channel and/or frequency band, e.g., a 2.4 Ghz band, as described below.

In some demonstrative aspects, for example, the one or more radios 144 may include, for example, a radio for communication by STA 157 over a second wireless communication frequency channel and/or frequency band, e.g., a 5 Ghz band, as described below.

In some demonstrative aspects, for example, the one or more radios 144 may include, for example, a radio for communication by STA 159 over a third wireless communication frequency channel and/or frequency band, e.g., a 6 Ghz band, as described below.

In some demonstrative aspects, for example, the one or more radios 144 may include, for example, a radio for communication by mmWave STA 161 over a fourth wireless communication frequency channel and/or frequency band, e.g., a mmWave band, as described below.

In some demonstrative aspects, the radios 144 utilized by STAs 153 may be implemented as separate radios. In other aspects, the radios 144 utilized by STAs 153 may be implemented by one or more shared and/or common radios and/or radio components.

In some demonstrative aspects, controller 154 may be configured to control, perform and/or to trigger, cause, instruct and/or control MLD 151 to operate as, perform a role of, and/or perform one or more operations and/or functionalities of, a non-AP MLD. For example, STA 155, STA 157, STA 159, and/or mmWave STA 161 may operate as, perform a role of, and/or perform one or more operations and/or functionalities of, a non-AP STA, e.g., a non-AP EHT STA.

In some demonstrative aspects, controller 154 may be configured to control, perform and/or to trigger, cause, instruct and/or control MLD 151 to operate as, perform a role of, and/or perform one or more operations and/or functionalities of, an AP MLD. For example, STA 155, STA 157, STA 159, and/or mmWave STA 161 may operate as, perform a role of, and/or perform one or more operations and/or functionalities of, an AP EHT STA.

In other aspects controller 154 may be configured to control, perform and/or to trigger, cause, instruct and/or control device 140 to operate as, perform a role of, and/or perform one or more operations and/or functionalities of, any other additional or alternative entity and/or STA, e.g., a single STA, multiple STAs, and/or a non-MLD entity.

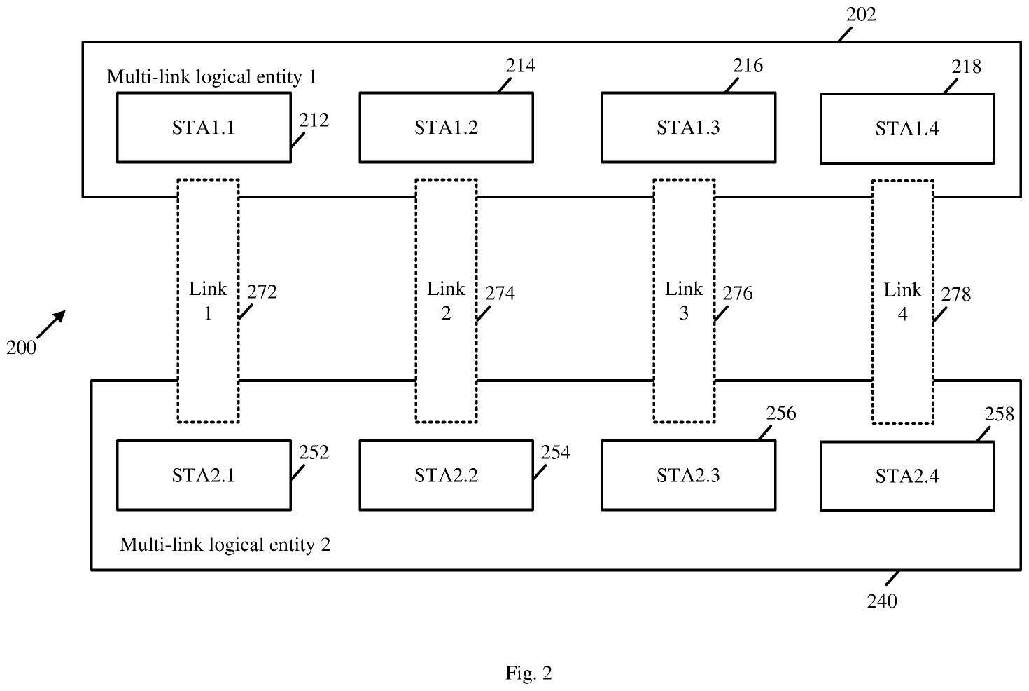

Reference is made to FIG. 2, which schematically illustrates a multi-link communication scheme 200, which may be implemented in accordance with some demonstrative aspects.

As shown in FIG. 2, a first multi-link logical entity 202 (“multi-link logical entity 1”), e.g., a first MLD, may include a plurality of STAs, e.g., including a STA 212, a STA 214, a STA 216, and a STA 218. In one example, AP MLD 131 (FIG. 1) may perform one or more operations of, one or more functionalities of, the role of, and/or the functionality of, multi-link logical entity 202.

As shown in FIG. 2, a second multi-link logical entity 240 (“multi-link logical entity 2”), e.g., a second MLD, may include a plurality of STAs, e.g., including a STA 252, a STA 254, a STA 256, and a STA 258. In one example, MLD 151 (FIG. 1) may perform one or more operations of, one or more functionalities of, the role of, and/or the functionality of, multi-link logical entity 240.

As shown in FIG. 2, multi-link logical entity 202 and multi-link logical entity 240 may be configured to form, setup and/or communicate over a plurality of links, for example, including a link 272 between STA 212 and STA 252, a link 274 between STA 214 and STA 254, a link 276 between STA 216 and STA 256, and/or a link 278 between STA 218 and STA 258.

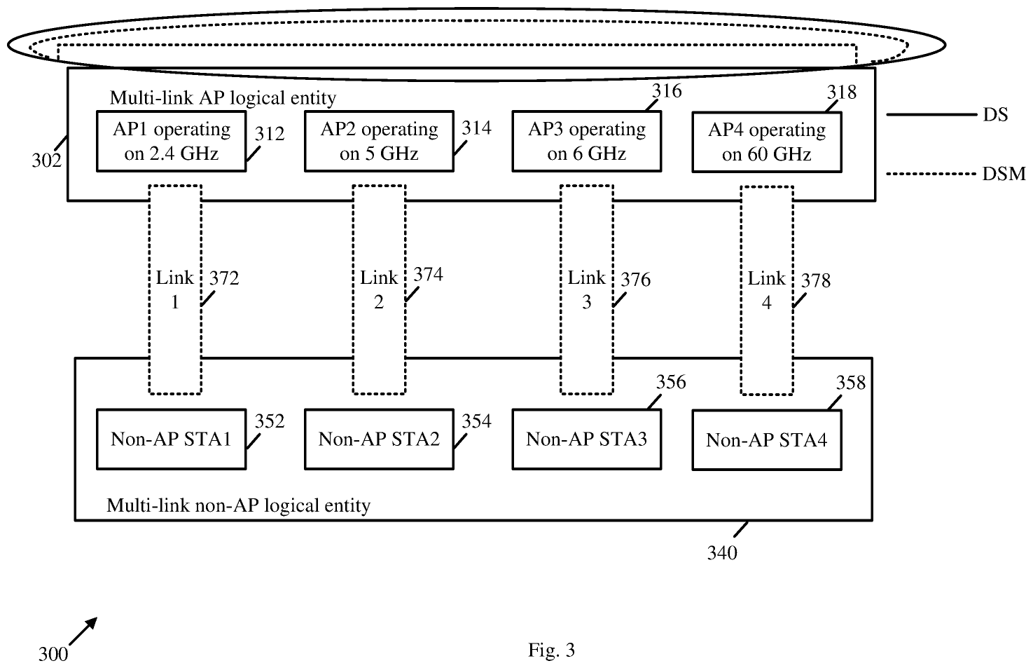

Reference is made to FIG. 3, which schematically illustrates a multi-link communication scheme 300, which may be implemented in accordance with some demonstrative aspects.

As shown in FIG. 3, a multi-link AP logical entity 302, e.g., an AP MLD, may include a plurality of AP STAs, e.g., including an AP STA 312, an AP STA 314, an AP STA 316, and an mmWave STA 318. In one example, AP MLD 131 (FIG. 1) may perform one or more operations of, one or more functionalities of, the role of, and/or the functionality of, multi-link AP logical entity 302.

As shown in FIG. 3, a multi-link non-AP logical entity 340, e.g., a non-AP MLD, may include a plurality of non-AP STAs, e.g., including a non-AP STA 352, a non-AP STA 354, a non-AP STA 356, and an mmWave STA 358. In one example, MLD 151 (FIG. 1) may perform one or more operations of, one or more functionalities of, the role of, and/or the functionality of, multi-link non-AP logical entity 340.

As shown in FIG. 3, multi-link AP logical entity 302 and multi-link non-AP logical entity 340 may be configured to form, setup and/or communicate over a plurality of links, for example, including a link 372 between AP STA 312 and non-AP STA 352, a link 374 between AP STA 314 and non-AP STA 354, a link 376 between AP STA 316 and non-AP STA 356, and/or a link 378 between mmWave STA 318 and mmWave STA 358.

For example, as shown in FIG. 3, multi-link AP logical entity 302 may include a multi-band AP MLD, which may be configured to communicate over a plurality of wireless communication frequency bands. For example, as shown in FIG. 3, AP STA 312 may be configured to communicate over a 2.4 Ghz frequency band, AP STA 314 may be configured to communicate over a 5 Ghz frequency band, AP STA 316 may be configured to communicate over a 6 Ghz frequency band, and/or mmWave STA 318 may be configured to communicate over a mmWave frequency band. In other aspects, AP STA 312, AP STA 314, AP STA 316, and/or mmWave STA 318 may be configured to communicate over any other additional or alternative wireless communication frequency bands.

Referring back to FIG. 1, in some demonstrative aspects, device 102 and/or device 140 may be configured to support a technical solution for communication between mmWave STAs, e.g., mmWave STA 141 and mmWave STA 161, over the mmWave frequency band, e.g., as described below.

In some demonstrative aspects, device 102 and/or device 140 may be configured to support a technical solution to utilize communications over the sub-10 GHz frequency band, for example, to assist one or more operations to be performed by the mmWave STAs, e.g., mmWave STA 141 and/or mmWave STA 161, over the mmWave frequency band, e.g., as described below.

In some demonstrative aspects, device 102 and/or device 140 may be configured to support a technical solution to utilize communications over the sub-10 GHz frequency band, for example, to assist a beamforming training procedure to be performed by the mmWave STAs, e.g., mmWave STA 141 and/or mmWave STA 161, over the mmWave frequency band, e.g., as described below.

In some demonstrative aspects, device 102 and/or device 140 may be configured to provide a technical solution to support mmWave operation, e.g., operation at the 60 GHz band, together with, and/or as part of, a sub-10 Ghz functionality, for example, of a mainstream Wi-Fi protocol, e.g., as described below.

In some demonstrative aspects, device 102 and/or device 140 may be configured to support a technical solution, which may be based on, and/or may utilize, cost reduction of a wireless communication architecture, which may allow to reuse at least some components of, e.g., as much as possible of, the same baseband, for communications by both a sub-10 GHz radio, e.g., a regular Wi-Fi radio, and a mmWave radio, e.g., a 60 GHz radio.

In some demonstrative aspects, device 102 and/or device 140 may be configured to support a technical solution, which may be based on, and/or may utilize, an enhanced throughput supported by mmWave techniques, e.g., compared to a sub-10 GHz band (lower band), which may have less potential for throughput enhancement.

In some demonstrative aspects, device 102 and/or device 140 may be configured to support a technical solution, which may be based on, and/or may utilize, a multi-link framework, for example, according to an MLD architecture, e.g., as described above.

In some demonstrative aspects, device 102 and/or device 140 may be configured to utilize the multi-link framework, for example, to improve operation on multiple links. In one example, the multi-link framework may be utilized to allow compensating for a fragility of an mmWave link, e.g., a 60 GHz link, for example, through a fallback to the sub-10 GHz band (lower band) operation.

In some demonstrative aspects, device 102 and/or device 140 may be configured to support a technical solution to utilize a beamforming (BF) training procedure, e.g., a Basic Beamforming Training (BBT) procedure, which may allow two or more STAs to train their analog smart antenna, for example, to determine the best sector to use to point in the direction of each other, for example, on transmit and/or receive directions, e.g., as described below.

In some demonstrative aspects, the basic beamforming training procedure may include a sector sweep by an initiator device to transmit training symbols and/or a training frame multiple times, for example, using different sectors, e.g., as described below.

In some demonstrative aspects, a receiver device (responder) may perform a receive sector sweep procedure, for example, during the sector sweep of the initiator device, e.g., as described below.

In other aspects, the receiver device may operate at an omni-receive mode to receive training frames from the initiator device.

In some demonstrative aspects, the receiver device may measure one or more values, e.g., a Received Signal Strength Indicator (RSSI), based on training frames that the receive device is capable of receiving from the initiator device.

In some demonstrative aspects, device 102 and/or device 140 may be configured to perform one or more operations of a beamforming training procedure to perform a sector sweep (also referred to as a “sounding phase”) on multiple transmit and/or receive antennas over an mmWave wireless communication channel, e.g., as described below.

In some demonstrative aspects, device 102 and/or device 140 may be configured to perform one or more phases of the beamforming training procedure over a sub-10 GHz band, and/or to perform one or more phases of the beamforming training procedure over a 60 GHz band, e.g., as described below.

In some demonstrative aspects, a first phase of the beamforming training procedure may include communication of a Trigger/Discovery frame, e.g., as described below.

In some demonstrative aspects, device 102 and/or device 140 may be configured to communicate the Trigger/Discovery frame over a sub-10 GHz link, for example, to initiate a sector sweep, e.g., as described below.

For example, the Trigger/Discovery frame may include, an NDP, a beamforming training frame, a Sounding Announcement frame, and/or any other type of frame, which may be configured to negotiate, setup and/or trigger the sector sweep, e.g., as described below.

In some demonstrative aspects, a second phase of the beamforming training procedure may include the sector sweep, e.g., as described below.

In some demonstrative aspects, device 102 and/or device 140 may be configured to perform the sector sweep, e.g., in the form of a sounding phase, over a 60 GHz channel, e.g., as described below.

In some demonstrative aspects, a third phase of the beamforming training procedure may include a feedback phase for communicating feedback information.

In some demonstrative aspects, device 102 and/or device 140 may be configured to communicate the feedback information, for example, as part of a sounding frame, a beamforming training feedback frame, and/or any other frame configured to communicate the feedback information, for example, after the sector sweep, e.g., as described below.

In some demonstrative aspects, the feedback information may be communicated, for example, over the sub-10 GHz link. In other aspects, the feedback information may be communicated, for example, over the mmWave channel.

In some demonstrative aspects, device 102 and/or device 140 may be configured to perform one or more, e.g., part of, the phases of the beamforming training procedure over the sub-10 GHz link, and/or one or more, e.g., part of, the phases of the beamforming training procedure over the 60 GHz channel, e.g., as described above.

In other aspects, device 102 and/or device 140 may be configured to perform communications of all phases of the beamforming training procedure over the mmWave channel. In one example, device 102 and/or device 140 may be configured to communicate the announcement/trigger frames, sounding phase frames, and/or any required feedback frames over the 60 GHz band.

In some demonstrative aspects, device 102 and/or device 140 may be configured to coordinate, setup and/or exchange information to establish a link in the 60 GHz band, for example, while using a lower band, e.g., the sub-10 Ghz band.

In some demonstrative aspects, operation over the mmWave band, e.g., the 60 GHz band, may require relatively high device power, e.g., compared to operation in lower bands, e.g., the sub-10 GHz band.

In some demonstrative aspects, the sub-10 Ghz band may be used to coordinate, setup and/or exchange the information to support establishment of the link in the 60 GHz band, for example, to provide a technical solution to reduce time and/or device power, for example, for a sector sweep performed over the mmWave band.

In some demonstrative aspects, device 102 and/or device 140 may be configured to support a technical solution to perform beamforming training, e.g., the basic beamforming training procedure and/or any other beamforming and/or beam-tracking procedure, over an mmWave wireless communication channel assisted by communications over a sub-10 GHz wireless communication channel, e.g., as described below.

In some demonstrative aspects, device 102 and/or device 140 may be configured to perform one or more operations of a procedure (also referred to as “sub-10 Ghz assisted procedure”), which may make use of an existing sub-10 Ghz link, e.g., a sub-7 GHz link, between two STAs that intend to establish an mmWave link, e.g., a 60 GHz link, to exchange discovery and/or beamforming training-related information, e.g., as described below.

In some demonstrative aspects, the sub-10 Ghz assisted procedure may be configured for implementation by a first STA, e.g., a STA implemented by device 102, and a second STA, e.g., a STA implemented by device 140, to perform discovery and/or initial beamforming training in the mmWave band, e.g., the 60 GHz band, for example, by exchanging related information on an existing sub-10 Ghz link, e.g., a sub-7 GHz link, as described below.

In some demonstrative aspects, the sub-10 Ghz assisted procedure may be configured for implementation by two STAs that have a sub-7 GHz link established to perform 60 GHz discovery and/or initial beamforming, e.g., as described below.

In some demonstrative aspects, for example, the sub-10 Ghz assisted procedure may include a first phase (phase 1), which may be configured to support the 60 GHz discovery and initial beamforming process. For example, the first phase may be initiated with the exchange of BF-assistance information on an existing sub-7 GHz link. For example, the BF-assistance information may include system parameters and/or system configuration information, e.g., a number of sectors, location information, and/or target start time, which may assist in configuring the BF over the mm Wave band.

In some demonstrative aspects, for example, the sub-10 Ghz assisted procedure may include a second phase (phase 2), which may be configured to support discovery and/or initial beamforming training over the mmWave band. For example, the second phase may include a transmit sector-sweep by an AP, e.g., using different sectors, and possibly other beamforming training procedures.

For example, during the phase 2, the sector-sweep by the AP may include transmission of training (TRN) signals in a MAC frame, a PPDU, and/or a Null Data Packet (NDP). For example, the AP may provide to a STA information, e.g., a sector identifier (ID) and/or basic service set identifier (BSSID), in PHY and/or MAC.

For example, the TRN signals may be configured in accordance with an IEEE 802.11ad/ay Specification. In another example, the TRN signal may have any other additional or alternative configuration.

For example, the TRN signals may be configured to include Long Training Field (LTF)/training sequences, which may be transmitted a plurality of times, e.g., X times. For example, a receiver STA may lock reception in an omni-directional receive mode, for example, based on a first part of a PPDU from the AP, and may use a different Rx sector, e.g., for each LTF/training sequence, for example, to perform Rx training.

In some demonstrative aspects for example, the sub-10 Ghz assisted procedure may include a third phase (phase 3), which may be configured to support feedback of the discovery and initial beamforming process, for example, over the existing sub-7 GHz link.

For example, the STA may be configured to send to the AP a feedback frame including feedback information, for example, based on measurements performed by the STA on the TRN signals received by the STA. For example, the feedback information may include an indication of one or more sectors, e.g., a best sector, which may be identified based on the measurements. For example, the feedback information may include some or all of the measurement information corresponding to the one or more sectors, e.g., an RSSI corresponding to the best sector, and/or any other additional or alternative information.

In some demonstrative aspects, the sub-10 Ghz assisted procedure may be implemented to provide a technical solution to support enhanced performance of the beamforming procedure, for example, from a throughput and/or power consumption perspective.

In some demonstrative aspects, device 102 and/or device 140 may be configured to perform a MIMO beamforming training sequence over an mmWave wireless communication channel, e.g., at 60 GHz, for example, during a sector sweep procedure, e.g., as described below.

In some demonstrative aspects, the MIMO beamforming training sequence may be configured to provide a technical solution to support executing the sector sweep procedure on multiple transmit and/or receive antennas in an mmWave band, e.g., as described below.

In some demonstrative aspects, the MIMO beamforming training sequence may be configured to provide a technical solution to assist device 102 and/or device 140 in executing the sector sweep procedure on multiple transmit and/or receive antennas, e.g., as described below. For example, an antenna, e.g., each antenna, may include multiple sectors to train, e.g., as described below.

In some demonstrative aspects, the MIMO beamforming training sequence may be configured to provide a technical solution to support the device 102 and/or the device 140 in determining one or more sectors, for example, a best sector. For example, the MIMO beamforming training sequence may be configured to provide a technical solution to support the device 102 and/or the device 140 in determining a best sector for a transmit and/or a receive antenna, for example, even for each transmit and/or a receive antenna, e.g., as described below.

In some demonstrative aspects, the MIMO beamforming training sequence may be configured to provide a technical solution to support a sector sweep on multiple transmit and/or receive antennas, for example, while allowing for MIMO sounding on one or more combinations, e.g., on each combination, of transmit sectors, e.g., as described below.

In some demonstrative aspects, the MIMO beamforming training sequence may be configured to provide a technical solution to support a sector sweep, e.g., to identify the best sector, for example, in addition to jointly obtaining a digital beamforming matrix for the best sector, e.g., as described below.

In some demonstrative aspects, an initiator device, e.g., an initiator device implemented by device 102, may communicate a MIMO beamforming training sequence over the mmWave wireless communication channel with a responder device, e.g., a responder device implemented by device 140.

In some demonstrative aspects, the responder device, e.g., the responder device implemented by device 140, may test different combinations of MIMO sectors and compare them.

In some demonstrative aspects, the responder device, e.g., the responder device implemented by device 140, may perform a channel estimation for one or more combinations of MIMO sectors, e.g., for each combination of MIMO sectors, for example, in accordance with a sounding protocol of a lower band, e.g., the sub-10 GHz band.

In some demonstrative aspects, the responder device, e.g., the responder device implemented by device 140, may calculate a MIMO beamforming feedback, which may be provided to the initiator device, for example, to perform digital beamforming.

In some demonstrative aspects, controller 124 may be configured to cause an mmWave STA implemented by device 102, e.g., mmWave STA 141, to transmit a preamble of a packet via a plurality of antennas of the mmWave STA over a mmWave wireless communication channel, e.g., as described below.

In some demonstrative aspects, the mmWave channel may include a 60 GHz channel. In other aspects, the mmWave channel may include any other mmWave channel.

In some demonstrative aspects, controller 124 may be configured to cause the mm Wave STA implemented by device 102 to transmit a MIMO TRN field of the packet over the mmWave wireless communication channel, e.g., as described below.

In some demonstrative aspects, the packet may be configured to include the MIMO TRN field after the preamble, e.g., as described below.

In some demonstrative aspects, the MIMO TRN field may include a sequence of a plurality of MIMO TRN subfields, which may be transmitted, for example, via the plurality of antennas of the mmWave STA implemented by device 102, e.g., as described below.

In some demonstrative aspects, a MIMO TRN subfield of the plurality of MIMO TRN subfields may include a plurality of TRN sequences, which may be, for example, simultaneously transmitted via the plurality of antennas of the mmWave STA implemented by device 102, respectively, e.g., as described below.

In some demonstrative aspects, controller 124 may be configured to cause the mmWave STA implemented by device 102 to transmit the preamble of the packet, for example, by transmitting a sequence of preamble fields, which may be, for example, duplicated via the plurality of antennas, e.g., as described below.

In some demonstrative aspects, the preamble of the packet may include a signal (SIG) field, e.g., as described below.

In some demonstrative aspects, the SIG field may include Identifier (ID) information to indicate a plurality of IDs corresponding to the plurality of antennas of the mmWave STA via which the MIMO TRN subfields are to be transmitted, e.g., as described below.

In some demonstrative aspects, the packet transmitted by the mmWave STA implemented by device 102 may include an NDP, e.g., as described below.

In some demonstrative aspects, the packet transmitted by the mmWave STA implemented by device 102 may include a PPDU, e.g., as described below.

In some demonstrative aspects, the PPDU may include a data field after the SIG field, and the MIMO TRN field may be after the data field, e.g., as described below.

In some demonstrative aspects, controller 124 may be configured to cause the mmWave STA implemented by device 102 to transmit a sequence of a plurality of sector-sweep packets, for example, via a respective plurality of antenna sector combinations, for example, during a Transmit Sector Sweep (TXSS), e.g., as described below.

In some demonstrative aspects, transmission of a sector-sweep packet via an antenna sector combination may include transmission of the preamble of the packet and the MIMO TRN field of the packet via the plurality of antennas, for example, according to the antenna sector combination, e.g., as described below.

In some demonstrative aspects, the antenna sector combination may include a combination of sectors of the plurality of antennas of the mmWave STA implemented by device 102, e.g., as described below.

In some demonstrative aspects, the plurality of antennas of the mm Wave STA implemented by device 102 may include a first antenna and a second antenna, e.g., as described below.

In some demonstrative aspects, the plurality of antenna sector combinations may include a plurality of different combinations of an antenna sector of the first antenna and an antenna sector of the second antenna, e.g., as described below.

In some demonstrative aspects, the MIMO TRN subfield may include a first TRN sequence and a second TRN sequence, which may be, for example, simultaneously transmitted via the first and second antennas, respectively, e.g., as described below.

In some demonstrative aspects, the MIMO TRN subfield may include a plurality of Long Training Fields (LTFs), e.g., as described below.

In some demonstrative aspects, the plurality of LTFs may include a plurality permutated repetitions of an LTF, e.g., as described below.

In some demonstrative aspects, the plurality of LTFs may include a plurality of permutations of an LTF according to a Permutation matrix (P-matrix), e.g., as described below.

In some demonstrative aspects, the plurality of TRN sequences may be configured to include a respective plurality of different LTF sequences, e.g., as described below.

In some demonstrative aspects, an LTF sequence of the plurality of different LTF sequences may be configured to include the plurality of permutated repetitions of the LTF, e.g., as described below.

In some demonstrative aspects, the plurality of different LTF sequences may be configured to be orthogonal to one another, e.g., as described below.

In some demonstrative aspects, the MIMO TRN subfield may include a Short Training Field (STF), for example, before the plurality of LTFs, e.g., as described below.

In some demonstrative aspects, the preamble of the packet including the MIMO TRN field may be configured to include the STF. For example, the MIMO TRN subfield may include a same STF as the STF in the preamble of the packet, e.g., as described below.

In some demonstrative aspects, the preamble of the packet including the MIMO TRN field may be configured to include an LTF.

In some demonstrative aspects, the plurality of LTFs in the MIMO TRN field may be based on the LTF in the preamble of the packet, e.g., as described below.

In some demonstrative aspects, the plurality of MIMO TRN subfields may be configured to be identical, e.g., as described below.

In other aspects, the plurality of MIMO TRN subfields may be configured to be different and/or partially identical. In other aspects, some or all of the MIMO TRN subfields may be different from one another.

In some demonstrative aspects, controller 154 may be configured to cause a first mmWave STA, for example, an mmWave STA implemented by device 140, e.g., mmWave STA 153, to process a preamble of a packet to identify that the packet includes a MIMO TRN field after the preamble, e.g., as described below.

In some demonstrative aspects, the first mmWave STA implemented by device 140 may receive the packet from a second mmWave STA over an mmWave wireless communication channel, e.g., as described below.

For example, the mmWave STA implemented by device 140 may be configured to receive the packet transmitted by the mmWave STA implemented by device 102 over the mmWave wireless communication channel.

For example, the mmWave STA implemented by device 140 may be configured to process the preamble of the packet from the mmWave STA implemented by device 102, for example, to identify that the packet includes the MIMO TRN field after the preamble.

In some demonstrative aspects, controller 154 may be configured to cause the mmWave STA implemented by device 140 to perform measurements on one or more received MIMO TRN subfields of the MIMO TRN field of the packet, e.g., as described below.

In some demonstrative aspects, the MIMO TRN field may include a sequence of a plurality of MIMO TRN subfields transmitted via a plurality of antennas of the mmWave STA implemented by device 102, e.g., as described below.

In some demonstrative aspects, a MIMO TRN subfield of the plurality of MIMO TRN subfields may include a plurality of TRN sequences simultaneously transmitted via the plurality of antennas of the mmWave STA implemented by device 102, e.g., as described below.

In some demonstrative aspects, controller 154 may be configured to cause the first mmWave STA implemented by device 140 to transmit feedback information to the mmWave STA implemented by device 102, e.g., as described below.

In some demonstrative aspects, the feedback information may be based on the measurements on the one or more received MIMO TRN subfields, e.g., as described below.

In some demonstrative aspects, the preamble of the packet communicated between the first mmWave STA, e.g., the mmWave STA implemented by device 140, and the second mmWave STA, e.g., the mmWave STA implemented by device 102, may include ID information to indicate a plurality of IDs corresponding to the plurality of antennas of the mmWave STA implemented by device 102, e.g., as described above.

In some demonstrative aspects, the feedback information transmitted from the mmWave STA implemented by device 140 to the mmWave STA implemented by device 102 may include one or more of the IDs in the packet, e.g., as described below.

In some demonstrative aspects, controller 124 may be configured to cause the mmWave STA implemented by device 102 to process the feedback information, which may be received, for example, in a packet from the mmWave STA implemented by device 140, e.g., as described below.

In some demonstrative aspects, the feedback information transmitted from the mmWave STA implemented by device 140 to the mmWave STA implemented by device 102 may be based, for example, on a measurement corresponding to the MIMO TRN field in the packet transmitted from the mmWave STA implemented by device 102 to the mmWave STA implemented by device 140, e.g., as described below.

In some demonstrative aspects, the feedback information may be based on a MIMO channel estimation, for example, based on the MIMO TRN field, e.g., as described below.

In some demonstrative aspects, controller 154 may be configured to cause the mmWave STA implemented by device 140 to generate the feedback information, for example, based on a MIMO channel estimation, which may be based, for example, on the one or more received MIMO TRN subfields, which are received by the mmWave STA implemented by device 140.

In some demonstrative aspects, the feedback information may include digital beamforming feedback information, e.g., as described below.

In some demonstrative aspects, the feedback information may be configured to include an indication of an identified combination of transmit sectors of the mmWave STA implemented by device 102, e.g., as described below.

In some demonstrative aspects, controller 154 may be configured to cause the first mmWave STA implemented by device 140 to identify the identified combination of transmit sectors of the mmWave STA implemented by device 102, for example, based on the measurement corresponding to the MIMO TRN field received from the mmWave STA implemented by device 102, e.g., as described below.

In some demonstrative aspects, the feedback information may include a beamforming report corresponding to the identified combination of transmit sectors of the mmWave STA implemented by device 102, which is identified by the mmWave STA implemented by device 140, for example, based on the measurement corresponding to the MIMO TRN field, e.g., as described below.

In some demonstrative aspects, the feedback information may include measurement information corresponding to the identified combination of transmit sectors of the mmWave STA implemented by device 102, which is identified by the mmWave STA implemented by device 140, for example, based on the measurement corresponding to the MIMO TRN field, e.g., as described below.

In other aspects, the feedback information may be configured to include any other additional or alternative information corresponding to the identified combination of transmit sectors of the mmWave STA implemented by device 102, which is identified by the mmWave STA implemented by device 140, for example, based on the measurement corresponding to the MIMO TRN field.

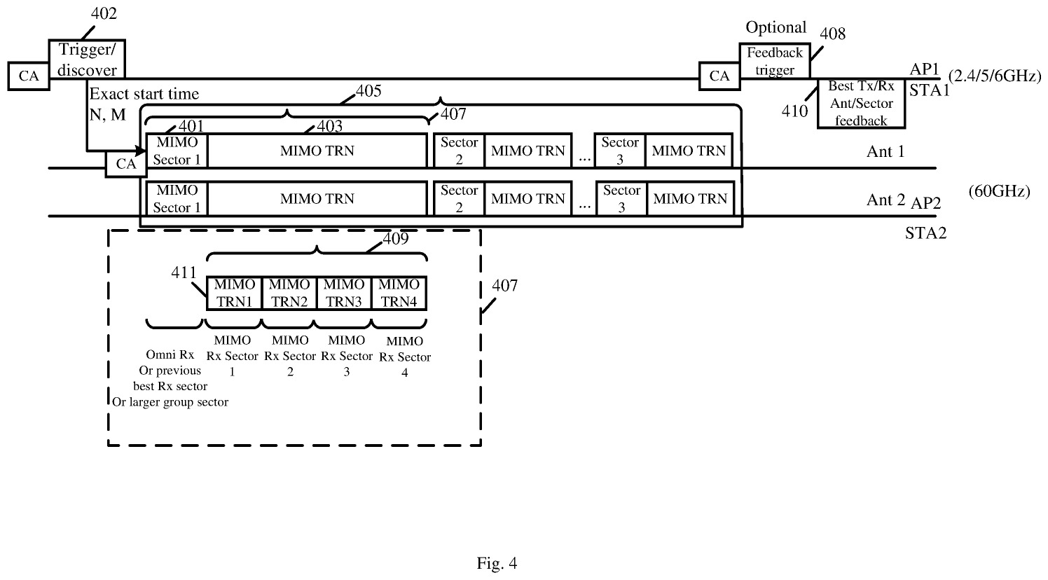

Reference is to FIG. 4, which schematically illustrates a beamforming training procedure over an mmWave wireless communication channel, in accordance with some demonstrative aspects.

In some demonstrative aspects, as shown in FIG. 4, one or more operations and/or communications of the procedure of FIG. 4 may be performed between an AP device, e.g., including a sub-10 Ghz AP and an mmWave AP; and a non-AP device, e.g., including a sub-10 Ghz non-AP STA and an mmWave non-AP STA. For example, controller 124 (FIG. 1) may be configured to control, trigger, and/or cause device 102 (FIG. 1) to perform a role of, one or more operations of, and/or one or more functionalities of, the AP device including the sub-10 Ghz AP and the mmWave AP; and/or controller 154 (FIG. 1) may be configured to control, trigger, and/or cause device 140 (FIG. 1) to perform a role of, one or more operations of, and/or one or more functionalities of, the non-AP device including the sub-10 Ghz non-AP STA and the mmWave non-AP STA.

In some demonstrative aspects, the AP device and the non-AP device may have a link established in a sub-7 GHz band, and may intend to establish a 60 GHz link as well.

In some demonstrative aspects, the AP device and the non-AP device may perform one or more operations configured to trigger 60 GHz discovery and initial beamforming, e.g., as described below.

In some demonstrative aspects, the AP device, e.g., the AP device implemented by device 102 (FIG. 1), may operate as, perform a role of, and perform one or more functionalities and/or operations of, an initiator device, which may be configured to transmit a MIMO-beamforming training sequence over the mmWave wireless communication channel, e.g., as described below.

In some demonstrative aspects, the non-AP device, e.g., the non-AP device implemented by device 140 (FIG. 1), may operate as, perform a role of, and perform one or more functionalities and/or operations of, a responder device, which may be configured to process the MIMO-beamforming training sequence received from the initiator device over the mmWave wireless communication channel, e.g., as described below.

In some demonstrative aspects, as shown in FIG. 4, a frame exchange, e.g., including one or more discovery and/or beamforming training setup frames 402 may be exchanged between the AP device and the non-AP device, for example, over the sub-10 GHz band, e.g., as described above. For example, during this frame exchange, capabilities and/or operating parameters related to 60 GHz operation may be exchanged, setup, and/or negotiated between the AP device and the non-AP device.

In some demonstrative aspects, as shown in FIG. 4, the start of the discovery and initial beamforming, e.g., in the 60 GHz band, may be “triggered”, for example, by the AP device, e.g., using a trigger frame 402.

In some demonstrative aspects, the AP device, e.g., the device implemented by device 102 (FIG. 1), may be configured to generate and/or transmit the beamforming training trigger frame 402. For example, device 102 (FIG. 1) may be configured to transmit the beamforming training trigger frame 402 from the sub-10 GHz AP of device 102 (FIG. 1) over a sub-10 GHz wireless communication channel.

In some demonstrative aspects, the non-AP device, e.g., the device implemented by device 140 (FIG. 1), may be configured to receive and/or process the beamforming training trigger frame 402. For example, device 140 (FIG. 1) may be configured to receive beamforming training trigger frame 402 at the sub-10 GHz non-AP STA of device 140 (FIG. 1) over the sub-10 GHz wireless communication channel.

In some demonstrative aspects, the beamforming training trigger frame 402 may be configured to communicate, e.g., over the sub-10 GHz link, configuration information to configure the beamforming training procedure over a mmWave wireless communication channel, e.g., as described below.

In some demonstrative aspects, the beamforming training trigger frame 402 may be configured to indicate, signal, set and/or negotiate one or more parameters to configure the beamforming training procedure over the mmWave wireless communication channel, e.g., as described below.

In some demonstrative aspects, as shown in FIG. 4, the configuration information may include a number of transmit sectors N, e.g., to be used by the AP device, a number of receive sectors M, e.g., to be used by the non-AP device, and/or a start time, e.g., an exact start time, of the beginning of a plurality of sector-sweep packets 405 to be transmitted by the AP device, e.g., in the role of the BF initiator device.

In some demonstrative aspects, the mmWave AP of device 102 (FIG. 1) may be configured to access the mmWave wireless communication channel for transmission of the plurality of sector-sweep packets 405, for example, based on the timing information indicating the target sequence start time of the beginning of the plurality of sector-sweep packets 405.

In some demonstrative aspects, as shown in FIG. 4, the mmWave AP of device 102 (FIG. 1) may be able to access the mmWave wireless communication channel for transmission of the plurality of sector-sweep packets 405, for example, at the exact start time, e.g., without a delay.

In some demonstrative aspects, the mmWave AP of device 102 (FIG. 1) may be configured to transmit the plurality of sector-sweep packets 405 via a plurality of antennas of device 102 (FIG. 1) over the mmWave wireless communication channel, for example, after the beamforming training trigger frame 402.

In some demonstrative aspects, device 102 (FIG. 1) may be configured to transmit the plurality of sector-sweep packets 405 via a respective plurality of antenna sector combinations, for example, during a TXSS.

In some demonstrative aspects, as shown in FIG. 4, a sector-sweep packet 407 of the plurality of sector-sweep packets 405 may include a preamble 401 and a MIMO TRN field 403 after the preamble 401.

In some demonstrative aspects, transmission of sector-sweep packet 407 via an antenna sector combination may include transmission of preamble 401 of sector-sweep packet 407 and MIMO TRN field 403 of sector-sweep packet 407 via the plurality of antennas according to the antenna sector combination.

In some demonstrative aspects, as shown in FIG. 4, MIMO TRN field 403 may include a sequence of a plurality of MIMO TRN subfields 409.

In some demonstrative aspects, a MIMO TRN subfield 411 of the plurality of MIMO TRN subfields 409 may include a plurality of TRN sequences simultaneously transmitted via the plurality of antennas, respectively.

In some demonstrative aspects, the AP device, e.g., the AP device implemented by device 102 (FIG. 1), may be configured to act as the initiator of the BF training, for example, to transmit sector-sweep packet 407 (also referred to as a “sounding frame”/“PPDU”) from both a first transmit antenna (“Ant 1”) of the AP device and a second transmit antenna (“Ant 2”) of the AP device.

In some demonstrative aspects, the AP device, e.g., the AP device implemented by device 102 (FIG. 1), may be configured to transmit the preamble 401 of sector-sweep packet 407 via the plurality of antennas of the mm Wave STA of device 102 (FIG. 1) over the mmWave wireless communication channel.

In some demonstrative aspects, as shown in FIG. 4, the non-AP device, e.g., the non-AP device implemented by device 140 (FIG. 1), may be configured to receive a first part of the sector-sweep packet 407, e.g., the preamble 401, in omni receive mode.

In some demonstrative aspects, as shown in FIG. 4, the non-AP device, e.g., the non-AP device implemented by device 140 (FIG. 1), may be configured to receive a first part of the sector-sweep packet 407, e.g., the preamble 401, using a previous best Rx sector, which may have been determined by the non-AP device based on a previous sector sweep.

In some demonstrative aspects, as shown in FIG. 4, the non-AP device, e.g., the non-AP device implemented by device 140 (FIG. 1), may be configured to receive a first part of the sector-sweep packet 407, e.g., the preamble 401, for example, using a larger Rx sector.

In some demonstrative aspects, the AP device, e.g., the mmWave AP of device 102 (FIG. 1), may be configured to duplicate preamble 401 on the two transmit antennas of the AP device.

In some demonstrative aspects, the AP device, e.g., the mmWave AP of device 102 (FIG. 1), may be configured to transmit the preamble 401 of the sector-sweep packet 407, for example, using a first combination of sectors of the AP device. For example, the first combination of sectors may include a combination of a Tx sector, e.g., a Tx sector 1-1, for a first Tx antenna, and a Tx sector, e.g., a Tx sector 2-1, for a second Tx antenna.

In some demonstrative aspects, a second part of the sector-sweep packet 407, e.g., MIMO TRN field 403, may be configured to provide a technical solute to support training of different MIMO Rx combinations of sectors, e.g., at the responder device.

For example, MIMO TRN field 403 may include a plurality of MIMO TRN subfields, e.g., including X MIMO TRN subfields, which may be configured to support, for example, training of X combinations of Rx sectors.

In some demonstrative aspects, the AP device, e.g., the mmWave AP of device 102 (FIG. 1), may be configured to transmit one or more MIMO TRN subfields, e.g., each MIMO TRN subfield, of the plurality of MIMO TRN subfields 409, for example, while using a combination of Tx sectors of the AP device.

For example, the AP device, e.g., the mmWave AP of device 102 (FIG. 1), may be configured to transmit the one or more MIMO TRN subfields 409, e.g., each MIMO TRN subfield 409, for example, while using a same combination of Tx sectors used by the AP device for transmission of preamble 401. In one example, the AP device may transmit one or more of the MIMO TRN subfields 409 of the sector-sweep packet 407, for example, using the first combination of sectors of the AP, e.g., the Tx sector 1-1 and the Tx sector 2-1.

In some demonstrative aspects, the non-AP device, e.g., the mmWave STA of device 140 (FIG. 1), may be configured to utilize a second combination of sectors, e.g., different from the combination of sectors used for receiving the preamble 401, for reception of one or more of the MIMO TRN subfields 409 of the sector-sweep packet 407. For example, the non-AP device, e.g., the mmWave STA of device 140 (FIG. 1), may utilize the second combination of sectors to attempt to receive each MIMO TRN subfield of the plurality of MIMO TRN subfields 409. For example, the second combination of sectors may include a combination of an Rx sector, e.g., an Rx sector 1-1, for a first Rx antenna, and an Rx sector, e.g., an Rx sector 2-1, for a second Rx antenna.

In some demonstrative aspects, as shown in FIG. 4, the AP device, e.g., the AP device implemented by device 102 (FIG. 1), may be configured to optionally transmit a feedback trigger frame 408, for example, to trigger a feedback frame 410 from the non-AP device, e.g., the non-AP device implemented by device 140 (FIG. 1). In one example, the feedback trigger frame 408 may be transmitted by the AP device over the sub-10 GHz band, e.g., as shown in FIG. 4. In another example, the feedback trigger frame 408 may be transmitted by the AP device over the mmWave band.

In some demonstrative aspects, as shown in FIG. 4, the non-AP device may be configured to transmit the feedback frame 410 over the sub-10 GHz wireless communication channel. In other aspects, the non-AP device may be configured to transmit the feedback frame 410 over the mmWave band.

In some demonstrative aspects, as shown in FIG. 4, the AP device, e.g., the AP device implemented by device 102 (FIG. 1), may be configured to receive the feedback frame 410 from the non-AP device, for example, over the sub-10 GHz wireless communication channel. In other aspects, the AP device may be configured to receive the feedback frame 410 over the mmWave band.

In some demonstrative aspects, device 102 (FIG. 1) may be configured to process the feedback frame 410 from device 140 (FIG. 1) to identify feedback information, for example, based on a measurement corresponding to the MIMO TRN subfields 409.

In some demonstrative aspects, the non-AP device, e.g., the non-AP device implemented by device 140 (FIG. 1), may be configured to include in the feedback frame 410 feedback information based on measurements performed on the sector-sweep packets 405. For example, the feedback information may include some or all of the following information and/or any other additional or alternative feedback information:
Sector identification information to indicate one or more identified sectors of the AP device. For example, the sector identification information may include information to identify a best combination of transmit sectors of the mmWave AP of device 102 (FIG. 1), e.g., as may be determined by device 140 (FIG. 1) based on the measurements on the MIMO TRN subfields 409. In another example, the sector identification information may optionally include, e.g., if needed/requested by the AP device, an indication of a best combination of receive sector of the mmWave STA of device 140 (FIG. 1), e.g., as may be determined by device 140 (FIG. 1) based on the measurements on the MIMO TRN subfields 409.
Beamforming report, for example, in compliance with a digital beamforming protocol in a lower band. For example, the beamforming report may include beamforming information corresponding to the best combination of the transmit and/or receive sectors. For example, the beamforming report may include a compressed, e.g., a “Wi-Fi8 compressed”, beamforming/Channel Quality Indicator (CQI) report.
RSSI/CQI and/or Compressed beamforming report for some, or even all, combinations of the transmit/receive sectors, e.g., including one or more combinations of the transmit/receive sectors different from the best Tx sector and the best Rx sector. For example, such a report may have higher overhead.

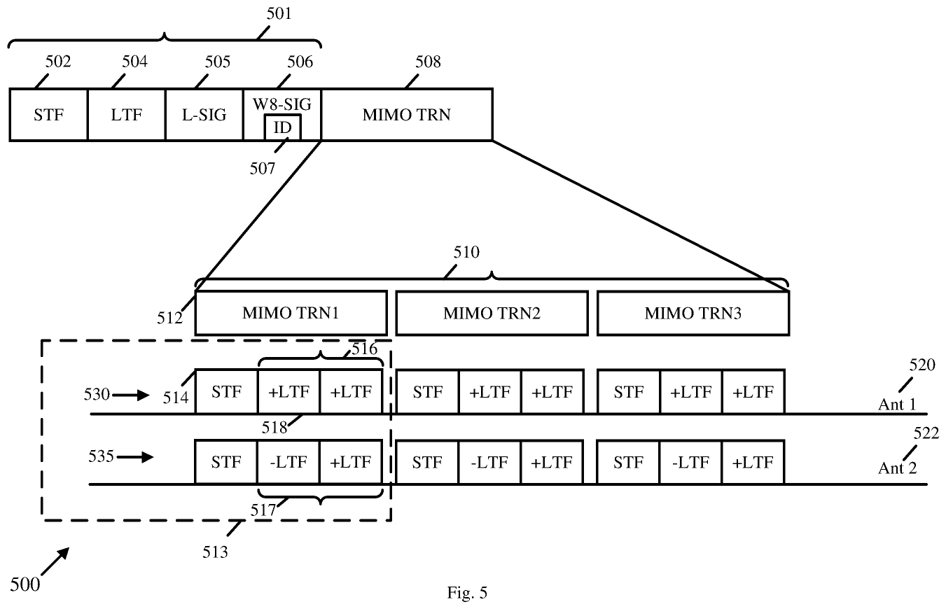

Reference is to FIG. 5, which schematically illustrates a packet 500, in accordance with some demonstrative aspects.

For example, a STA implemented by device 102 (FIG. 1) and/or a STA implemented by device 140 (FIG. 1) may be configured to generate, transmit, and/or process packet 500, e.g., as a sounding frame for MIMO beamforming training over the mmWave band.

In some demonstrative aspects, as shown in FIG. 5, a preamble 501 of the packet 500 may include an STF 502, an LTF 504 after STF 502, and a SIG field 506 (also referred to as “Wi-Fi 8 SIG” or “W8-SIG”), e.g., after LTF 504. For example, the SIG field 506 may be after a non-High Throughput SIG (L-SIG) field 505.

In some demonstrative aspects, packet 500 may include an NDP, e.g., which may not include a data field after the preamble 501. In other aspects, packet 500 may include any other type of packet and/or PPDU, which may include a data field after the preamble 501.

In some demonstrative aspects, as shown in FIG. 5, a STA, e.g., the STA implemented by device 102 (FIG. 1), may be configured to transmit preamble 501 of the packet 500 via a plurality of antennas of the STA over an mmWave wireless communication channel.

In some demonstrative aspects, as shown in FIG. 5, the STA may transmit the packet 500 via a first antenna 520 and a second antenna 522 of the STA.

In some demonstrative aspects, as shown in FIG. 5, SIG field 506 may include ID information 507 configured to indicate a plurality of IDs corresponding to the plurality of antennas of the STA. For example, ID information 507 may be configured to indicate a first ID corresponding to the first antenna 520, and/or a second ID corresponding to the second antenna 522.

In some demonstrative aspects, as shown in FIG. 5, the packet 500 may include a MIMO TRN field 508 after the preamble 501.

In some demonstrative aspects, as shown in FIG. 5, MIMO TRN field 508 may include a sequence of a plurality of MIMO TRN subfields 510. In one example, the plurality of MIMO TRN subfields 510 may be identical. In other aspects, the MIMO TRN subfields 510 may include two or more MIMO TRN fields, which may be different from one another.

In some demonstrative aspects, as shown in FIG. 5, a MIMO TRN subfield 512 of the plurality of MIMO TRN subfields 510 may include a plurality of TRN sequences 513, which may be simultaneously transmitted via the plurality of antennas of the STA, respectively.

In some demonstrative aspects, as shown in FIG. 5, the plurality of TRN sequences 513 may include a first TRN sequence 530, and a second TRN sequence 535.

In some demonstrative aspects, the first TRN sequence 530 and the second TRN sequence 535 may be simultaneously transmitted via the first antenna 520 and the second antenna 522, respectively.

In some demonstrative aspects, as shown in FIG. 5, MIMO TRN subfield 512 may include an STF 514. For example, the STF 514 may include, or may be identical to, STF 502.

In some demonstrative aspects, as shown in FIG. 5, MIMO TRN subfield 512 may include in the first TRN sequence 530 a plurality of LTFs 516 after the STF 514. For example, the plurality of LTFs 516 may be based on the LTF 504.

In some demonstrative aspects, the plurality of LTFs 516 may include a plurality permutated repetitions of an LTF 518.

In some demonstrative aspects, the plurality of LTFs 516 may include a plurality of permutations of LTF 518 according to a P-matrix. In other aspects, any other permutation may be implemented.

In some demonstrative aspects, as shown in FIG. 5, the plurality of TRN sequences 513 may include a respective plurality of different LTF sequences. For example, the plurality of TRN sequences 513 may include a first LTF sequence including the plurality of LTFs 516 in the first TRN sequence 530, and a second LTF sequence including a plurality of LTFs 517 in the second TRN sequence 535.

In some demonstrative aspects, the plurality of LTF sequences may be orthogonal to one another.

In some demonstrative aspects, a first part of the packet 500, e.g., preamble 501, may include one or more fields, e.g., the STF 502 and/or the LTF 504, which may be configured to detect, synchronize and/or estimate a channel, e.g., an mmWave wireless communication channel, to receive one or more SIG fields, e.g., the L-SIG 505 and/or the SIG field 506.

In some demonstrative aspects, SIG field 506 may include information regarding packet 500.

For example, SIG filed 506 may include some or all of the following information and/or any other additional or alternative information:
Address of a transmitter of packet 500.
Address of a receiver of the packet 500. In some use cases this information may be optional.
MIMO-sector combination information corresponding to a combination of MIMO sectors to be trained by the MIMO TRN field 508 of the packet 500. In one example, the SIG field 506 may include the MIMO-sector combination information in the form of at least one sector ID field 507 for at least one antenna, e.g., for an ID field 507 per each transmit antenna being used for the transmission of the MIMO TRN field 508 of the packet 500. In another example, the SIG field 506 may include the MIMO-sector combination information in the form of a sector combination ID field 507, which may be configured to point to a combination of sectors being used for the transmission of the MIMO TRN field 508 of the packet 500. This implementation of the sector combination ID field 507 may be utilized, for example, in case a receiver device may map the sector combination ID to an exact sector ID, for example, for each of the transmit antennas of the STA transmitting the packet 500.

In some demonstrative aspects, a second part of the packet 500, e.g., MIMO TRN field 508, may include the plurality of MIMO TRN subfields 510, which may be configured, for example, to train different combinations of Rx sectors of a receiver STA.

In some demonstrative aspects, a MIMO TRN subfield 512 of the plurality of MIMO TRN subfields 510 may include the STF field 514 followed by the plurality of LTFs 516, e.g., as described above.

In other aspects, MIMO TRN subfield 512 may include any other additional or alternative combination of STF fields, LTF fields, and/or any other training fields and/or training sequences, which may support multiple-antenna training.

In some demonstrative aspects, MIMO TRN subfield 512 may be configured to include multiple LTF symbols in time, for example, to support multiplication of the LTF symbols by a P-matrix, e.g., a P-matrix in compliance with a sounding protocol in the lower band.

In some demonstrative aspects, MIMO TRN subfield 512 may include one LTF symbol for each antenna utilized by the transmitter STA transmitting the packet 500.

In one example, MIMO TRN subfield 512 may include two LTF symbols, for example, when the transmitter STA utilizes two antennas for transmission of two TRN sequences.

In one example, MIMO TRN subfield 512 may include four LTF symbols, for example, when the transmitter STA utilizes four antennas for transmission of four TRN sequences.

In some demonstrative aspects, the P-matrix may be configured as an orthogonal P-matrix, for example, to provide a technical solution to support the receiver device to extract sounding information, for example, from each antenna separately.

In some demonstrative aspects, the orthogonality of the P-matrix may provide a technical solution to support the receiver device to use different combinations of sectors, e.g., a sector for each Rx antenna, for example, with respect to each MIMO TRN subfield 512.

In some demonstrative aspects, the orthogonality of the P-matrix may provide a technical solution to support the receiver device in performing a MIMO channel estimation, for example, in compliance with a sounding phase protocol in the lower band. For example, the receiver device may derive channel estimations, for example, for one or more antennas, e.g., on each antenna, and/or may calculate beamforming feedback estimates, for example, in order to support digital beamforming.

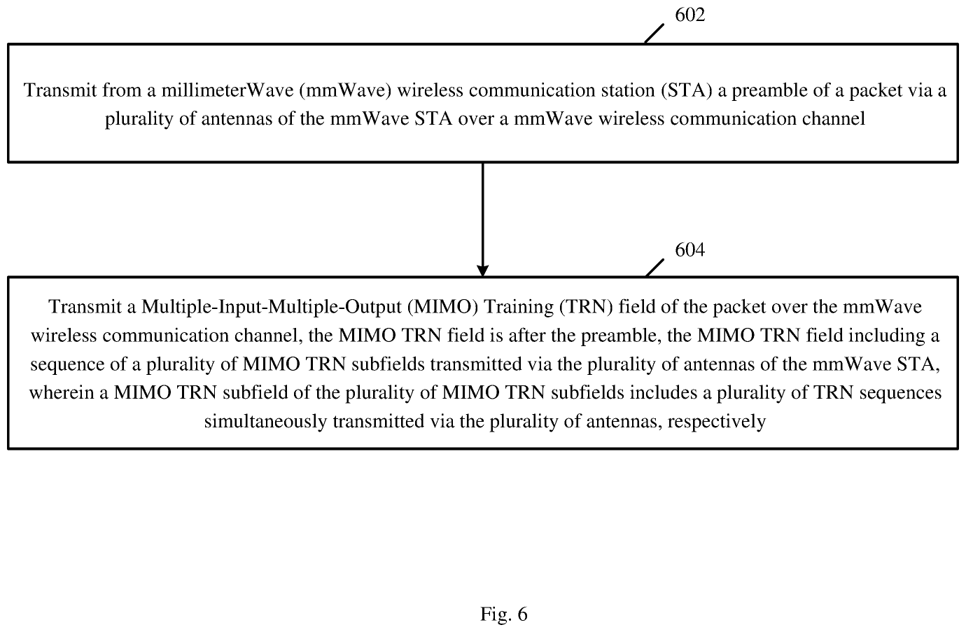

Reference is made to FIG. 6, which schematically illustrates a method of communicating a packet including a MIMO TRN field, in accordance with some demonstrative aspects. For example, one or more of the operations of the method of FIG. 6 may be performed by one or more elements of a system, e.g., system 100 (FIG. 1), for example, one or more wireless devices, e.g., device 102 (FIG. 1), and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 602, the method may include transmitting from an mmWave STA a preamble of a packet via a plurality of antennas of the mmWave STA over a mmWave wireless communication channel. For example, controller 124 (FIG. 1) may be configured to cause, trigger, and/or control device 102 (FIG. 1) to transmit the preamble 501 (FIG. 5) of the packet 500 (FIG. 5) via the plurality of antennas of the mmWave STA over the mmWave wireless communication channel, e.g., as described above.

As indicated at block 604, the method may include transmitting a MIMO TRN field of the packet over the mmWave wireless communication channel. For example, the MIMO TRN field may be after the preamble, and may include a sequence of a plurality of MIMO TRN subfields transmitted via the plurality of antennas of the mmWave STA. For example, a MIMO TRN subfield of the plurality of MIMO TRN subfields may include a plurality of TRN sequences, for example, simultaneously transmitted via the plurality of antennas, respectively. For example, controller 124 (FIG. 1) may be configured to cause, trigger, and/or control device 102 (FIG. 1) to transmit the MIMO TRN field 508 (FIG. 5) of the packet 500 (FIG. 5) over the mmWave wireless communication channel, e.g., as described above.

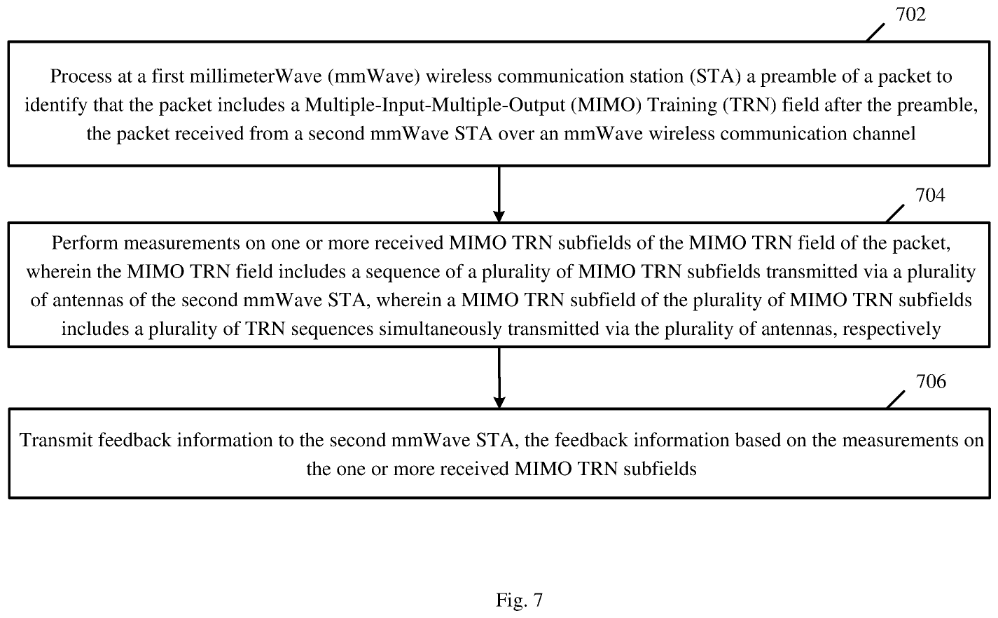

Reference is made to FIG. 7, which schematically illustrates a method of communicating a packet including a MIMO TRN field, in accordance with some demonstrative aspects. For example, one or more of the operations of the method of FIG. 7 may be performed by one or more elements of a system, e.g., system 100 (FIG. 1), for example, one or more wireless devices, e.g., device 102 (FIG. 1) and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 702, the method may include processing at a first mmWave STA a preamble of a packet to identify that the packet includes a MIMO TRN field after the preamble. For example, the packet may be received from a second mmWave STA over an mmWave wireless communication channel. For example, controller 154 (FIG. 1) may be configured to cause, trigger, and/or control device 140 (FIG. 1) to process the preamble 501 (FIG. 5) of the packet 500 (FIG. 5), e.g., received from device 102 (FIG. 1), to identify that the packet 500 (FIG. 5) includes the MIMO TRN field 508 (FIG. 5) after the preamble 501 (FIG. 5), e.g., as described above.

As indicated at block 704, the method may include performing measurements on one or more received MIMO TRN subfields of the MIMO TRN field of the packet. For example, the MIMO TRN field may include a sequence of a plurality of MIMO TRN subfields transmitted via a plurality of antennas of the second mmWave STA. For example, a MIMO TRN subfield of the plurality of MIMO TRN subfields may include a plurality of TRN sequences simultaneously transmitted via the plurality of antennas, respectively. For example, controller 154 (FIG. 1) may be configured to cause, trigger, and/or control device 140 (FIG. 1) to perform measurements on one or more received MIMO TRN subfields 510 (FIG. 5) of the MIMO TRN field 508 (FIG. 5) of the packet 500 (FIG. 5), e.g., as described above.

As indicated at block 706, the method may include transmitting feedback information to the second mmWave STA. For example, the feedback information may be based on the measurements on the one or more received MIMO TRN subfields. For example, controller 154 (FIG. 1) may be configured to cause, trigger, and/or control device 140 (FIG. 1) to transmit the feedback information to device 102 (FIG. 1), e.g., as described above.

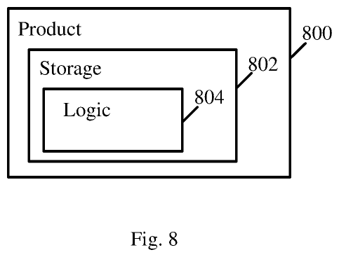

Reference is made to FIG. 8, which schematically illustrates a product of manufacture 800, in accordance with some demonstrative aspects. Product 800 may include one or more tangible computer-readable (“machine-readable”) non-transitory storage media 802, which may include computer-executable instructions, e.g., implemented by logic 804, operable to, when executed by at least one computer processor, enable the at least one computer processor to implement one or more operations at device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1); to cause device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to perform, trigger and/or implement one or more operations and/or functionalities; and/or to perform, trigger and/or implement one or more operations and/or functionalities described with reference to the FIGS. 1, 2, 3, 4, 5, 6, and/or 7, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 800 and/or machine-readable storage media 802 may include one or more types of computer-readable storage media capable of storing data, including volatile memory, non-volatile memory, removable or non-removable memory, erasable or non-erasable memory, writeable or re-writeable memory, and the like. For example, machine-readable storage media 802 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 804 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 804 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause a millimeterWave (mmWave) wireless communication station (STA) to transmit a preamble of a packet via a plurality of antennas of the mmWave STA over a mmWave wireless communication channel; and transmit a Multiple-Input-Multiple-Output (MIMO) Training (TRN) field of the packet over the mmWave wireless communication channel, the MIMO TRN field is after the preamble, the MIMO TRN field comprising a sequence of a plurality of MIMO TRN subfields transmitted via the plurality of antennas of the mmWave STA, wherein a MIMO TRN subfield of the plurality of MIMO TRN subfields comprises a plurality of TRN sequences simultaneously transmitted via the plurality of antennas, respectively.

Example 2 includes the subject matter of Example 1, and optionally, wherein the apparatus is configured to cause the mmWave STA to transmit a sequence of a plurality of sector-sweep packets via a respective plurality of antenna sector combinations during a Transmit Sector Sweep (TXSS), wherein transmission of a sector-sweep packet via an antenna sector combination comprises transmission of the preamble of the packet and the MIMO TRN field of the packet via the plurality of antennas according to the antenna sector combination, wherein the antenna sector combination comprises a combination of sectors of the plurality of antennas.

Example 3 includes the subject matter of Example 2, and optionally, wherein the plurality of antennas of the mmWave STA comprises a first antenna and a second antenna, wherein the plurality of antenna sector combinations comprises a plurality of different combinations of an antenna sector of the first antenna and an antenna sector of the second antenna.

Example 4 includes the subject matter of any one of Examples 1-3, and optionally, wherein the MIMO TRN subfield comprises a plurality of Long Training Fields (LTFs).

Example 5 includes the subject matter of Example 4, and optionally, wherein the MIMO TRN subfield comprises a Short Training Field (STF) before the plurality of LTFs.

Example 6 includes the subject matter of Example 5, and optionally, wherein the preamble of the packet comprises the STF.

Example 7 includes the subject matter of any one of Examples 4-6, and optionally, wherein the plurality of LTFs comprises a plurality permutated repetitions of an LTF.

Example 8 includes the subject matter of any one of Examples 4-7, and optionally, wherein the plurality of LTFs comprises a plurality of permutations of an LTF according to a Permutation matrix (P-matrix).

Example 9 includes the subject matter of any one of Examples 4-8, and optionally, wherein the plurality of TRN sequences comprises a respective plurality of different LTF sequences, an LTF sequence comprising a plurality of permutated repetitions of an LTF.

Example 10 includes the subject matter of Example 9, and optionally, wherein the plurality of different LTF sequences are orthogonal to one another.

Example 11 includes the subject matter of any one of Examples 4-10, and optionally, wherein the preamble of the packet comprises an LTF, wherein the plurality of LTFs are based on the LTF.

Example 12 includes the subject matter of any one of Examples 1-11, and optionally, wherein the apparatus is configured to cause the mmWave STA to transmit the preamble of the packet by transmitting a sequence of preamble fields duplicated via the plurality of antennas.

Example 13 includes the subject matter of any one of Examples 1-12, and optionally, wherein the plurality of MIMO TRN subfields are identical.

Example 14 includes the subject matter of any one of Examples 1-13, and optionally, wherein the preamble of the packet comprises a signal (SIG) field, the SIG field comprising Identifier (ID) information to indicate a plurality of IDs corresponding to the plurality of antennas.

Example 15 includes the subject matter of any one of Examples 1-14, and optionally, wherein the apparatus is configured to cause the mmWave STA to process feedback information in an other packet from an other STA, the feedback information based on a measurement corresponding to the MIMO TRN field.

Example 16 includes the subject matter of Example 15, and optionally, wherein the feedback information is based on a MIMO channel estimation based on the MIMO TRN field.

Example 17 includes the subject matter of Example 15 or 16, and optionally, wherein the feedback information comprises digital beamforming feedback information.

Example 18 includes the subject matter of any one of Examples 15-17, and optionally, wherein the feedback information comprises an indication of an identified combination of transmit sectors of the mmWave STA, which is identified by the other STA based on the measurement corresponding to the MIMO TRN field.

Example 19 includes the subject matter of any one of Examples 15-18, and optionally, wherein the feedback information comprises a beamforming report corresponding to an identified combination of transmit sectors of the mmWave STA, which is identified by the other STA based on the measurement corresponding to the MIMO TRN field.

Example 20 includes the subject matter of any one of Examples 15-19, and optionally, wherein the feedback information comprises measurement information corresponding to an identified combination of transmit sectors of the mmWave STA, which is identified by the other STA based on the measurement corresponding to the MIMO TRN field.

Example 21 includes the subject matter of any one of Examples 1-20, and optionally, wherein the plurality of antennas of the mmWave STA comprises a first antenna and a second antenna, wherein the MIMO TRN subfield comprises a first TRN sequence and a second TRN sequence simultaneously transmitted via the first and second antennas, respectively.

Example 22 includes the subject matter of any one of Examples 1-21, and optionally, wherein the packet comprises a Null-Data-Packet (NDP).

Example 23 includes the subject matter of any one of Examples 1-21, and optionally, wherein the packet comprises a Physical layer (PHY) Protocol Data Unit (PPDU) comprising a data field after the SIG field, wherein the MIMO TRN field is after the data field.

Example 24 includes the subject matter of any one of Examples 1-23, and optionally, wherein the mmWave wireless communication channel comprises a 60 GHz channel.

Example 25 includes the subject matter of any one of Examples 1-24, and optionally, comprising a radio to transmit the packet over the mmWave wireless communication channel.

Example 26 includes the subject matter of Example 25, and optionally, comprising one or more antennas connected to the radio, and a processor to execute instructions of an operating system of the mmWave STA.

Example 27 includes an apparatus comprising logic and circuitry configured to cause a first millimeterWave (mmWave) wireless communication station (STA) to process a preamble of a packet to identify that the packet comprises a Multiple-Input-Multiple-Output (MIMO) Training (TRN) field after the preamble, the packet received from a second mmWave STA over an mmWave wireless communication channel; perform measurements on one or more received MIMO TRN subfields of the MIMO TRN field of the packet, wherein the MIMO TRN field comprises a sequence of a plurality of MIMO TRN subfields transmitted via a plurality of antennas of the second mmWave STA, wherein a MIMO TRN subfield of the plurality of MIMO TRN subfields comprises a plurality of TRN sequences simultaneously transmitted via the plurality of antennas, respectively; and transmit feedback information to the second mmWave STA, the feedback information based on the measurements on the one or more received MIMO TRN subfields.

Example 28 includes the subject matter of Example 27, and optionally, wherein the feedback information is based on a MIMO channel estimation based on the one or more received MIMO TRN subfields.

Example 29 includes the subject matter of Example 27 or 28, and optionally, wherein the feedback information comprises digital beamforming feedback information.

Example 30 includes the subject matter of any one of Examples 27-29, and optionally, wherein the feedback information comprises an indication of an identified combination of transmit sectors of the second mmWave STA, which is identified by the first mmWave STA based on the measurements corresponding to the one or more received MIMO TRN subfields.

Example 31 includes the subject matter of any one of Examples 27-30, and optionally, wherein the feedback information comprises a beamforming report corresponding to an identified combination of transmit sectors of the second mmWave STA, which is identified by the first mmWave STA based on the measurements corresponding to the one or more received MIMO TRN subfields.

Example 32 includes the subject matter of any one of Examples 27-31, and optionally, wherein the feedback information comprises measurement information corresponding to an identified combination of transmit sectors of the second mmWave STA, which is identified by the first mmWave STA based on the measurements corresponding to the one or more received MIMO TRN subfields.

Example 33 includes the subject matter of any one of Examples 27-32, and optionally, wherein the MIMO TRN subfield comprises a plurality of Long Training Fields (LTFs).

Example 34 includes the subject matter of Example 33, and optionally, wherein the MIMO TRN subfield comprises a Short Training Field (STF) before the plurality of LTFs.

Example 35 includes the subject matter of Example 34, and optionally, wherein the preamble of the packet comprises the STF.

Example 36 includes the subject matter of any one of Examples 33-35, and optionally, wherein the plurality of LTFs comprises a plurality permutated repetitions of an LTF.

Example 37 includes the subject matter of any one of Examples 33-36, and optionally, wherein the plurality of LTFs comprises a plurality of permutations of an LTF according to a Permutation matrix (P-matrix).

Example 38 includes the subject matter of any one of Examples 33-37, and optionally, wherein the plurality of TRN sequences comprises a respective plurality of different LTF sequences, an LTF sequence comprising a plurality of permutated repetitions of an LTF.

Example 39 includes the subject matter of Example 38, and optionally, wherein the plurality of different LTF sequences are orthogonal to one another.

Example 40 includes the subject matter of any one of Examples 33-39, and optionally, wherein the preamble of the packet comprises an LTF, wherein the plurality of LTFs are based on the LTF.

Example 41 includes the subject matter of any one of Examples 27-40, and optionally, wherein the plurality of MIMO TRN subfields are identical.

Example 42 includes the subject matter of any one of Examples 27-41, and optionally, wherein the preamble of the packet comprises a signal (SIG) field, the SIG field comprising Identifier (ID) information to indicate a plurality of IDs corresponding to the plurality of antennas, wherein the feedback information includes one or more of the IDs.

Example 43 includes the subject matter of any one of Examples 27-42, and optionally, wherein the plurality of antennas of the second mmWave STA comprises a first antenna and a second antenna, wherein the MIMO TRN subfield comprises a first TRN sequence and a second TRN sequence simultaneously transmitted via the first and second antennas, respectively.

Example 44 includes the subject matter of any one of Examples 27-43, and optionally, wherein the packet comprises a Null-Data-Packet (NDP).

Example 45 includes the subject matter of any one of Examples 27-44, and optionally, wherein the packet comprises a Physical layer (PHY) Protocol Data Unit (PPDU) comprising a data field after the SIG field, wherein the MIMO TRN field is after the data field.

Example 46 includes the subject matter of any one of Examples 27-45, and optionally, wherein the mmWave wireless communication channel comprises a 60 GHz channel.

Example 47 includes the subject matter of any one of Examples 27-46, and optionally, comprising a radio to receive the packet and to transmit the feedback information over the mmWave wireless communication channel.

Example 48 includes the subject matter of Example 47, and optionally, comprising one or more antennas connected to the radio, and a processor to execute instructions of an operating system of the first mmWave STA.

Example 49 comprises a wireless communication device comprising the apparatus of any of Examples 1-48.

Example 50 comprises an apparatus comprising means for executing any of the described operations of any of Examples 1-48.

Example 51 comprises a product comprising one or more tangible computer-readable non-transitory storage media comprising computer-executable instructions operable to, when executed by at least one processor, enable the at least one processor to cause a wireless communication device to perform any of the described operations of any of Examples 1-48.

Example 52 comprises an apparatus comprising: a memory interface; and processing circuitry configured to: perform any of the described operations of any of Examples 1-48.

Example 53 comprises a method comprising any of the described operations of any of Examples 1-48.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1-25. (canceled)

26. An apparatus comprising logic and circuitry configured to cause a millimeterWave (mmWave) wireless communication station (STA) to:
transmit a preamble of a packet via a plurality of antennas of the mmWave STA over a mmWave wireless communication channel; and
transmit a Multiple-Input-Multiple-Output (MIMO) Training (TRN) field of the packet over the mmWave wireless communication channel, the MIMO TRN field is after the preamble, the MIMO TRN field comprising a sequence of a plurality of MIMO TRN subfields transmitted via the plurality of antennas of the mm Wave STA, wherein a MIMO TRN subfield of the plurality of MIMO TRN subfields comprises a plurality of TRN sequences simultaneously transmitted via the plurality of antennas, respectively.

27. The apparatus of claim 26 configured to cause the mmWave STA to transmit a sequence of a plurality of sector-sweep packets via a respective plurality of antenna sector combinations during a Transmit Sector Sweep (TXSS), wherein transmission of a sector-sweep packet via an antenna sector combination comprises transmission of the preamble of the packet and the MIMO TRN field of the packet via the plurality of antennas according to the antenna sector combination, wherein the antenna sector combination comprises a combination of sectors of the plurality of antennas.

28. The apparatus of claim 27, wherein the plurality of antennas of the mmWave STA comprises a first antenna and a second antenna, wherein the plurality of antenna sector combinations comprises a plurality of different combinations of an antenna sector of the first antenna and an antenna sector of the second antenna.

29. The apparatus of claim 26, wherein the MIMO TRN subfield comprises a plurality of Long Training Fields (LTFs).

30. The apparatus of claim 29, wherein the MIMO TRN subfield comprises a Short Training Field (STF) before the plurality of LTFs.

31. The apparatus of claim 30, wherein the preamble of the packet comprises the STF.

32. The apparatus of claim 29, wherein the plurality of LTFs comprises a plurality permutated repetitions of an LTF.

33. The apparatus of claim 29, wherein the plurality of LTFs comprises a plurality of permutations of an LTF according to a Permutation matrix (P-matrix).

34. The apparatus of claim 29, wherein the plurality of TRN sequences comprises a respective plurality of different LTF sequences, an LTF sequence comprising a plurality of permutated repetitions of an LTF.

35. The apparatus of claim 34, wherein the plurality of different LTF sequences are orthogonal to one another.

36. The apparatus of claim 29, wherein the preamble of the packet comprises an LTF, wherein the plurality of LTFs are based on the LTF.

37. The apparatus of claim 26 configured to cause the mmWave STA to transmit the preamble of the packet by transmitting a sequence of preamble fields duplicated via the plurality of antennas.

38. The apparatus of claim 26, wherein the plurality of MIMO TRN subfields are identical.

39. The apparatus of claim 26, wherein the preamble of the packet comprises a signal (SIG) field, the SIG field comprising Identifier (ID) information to indicate a plurality of IDs corresponding to the plurality of antennas.

40. The apparatus of claim 26 configured to cause the mmWave STA to process feedback information in an other packet from an other STA, the feedback information based on a measurement corresponding to the MIMO TRN field.

41. The apparatus of claim 40, wherein the feedback information is based on a MIMO channel estimation based on the MIMO TRN field.

42. The apparatus of claim 26, wherein the plurality of antennas of the mmWave STA comprises a first antenna and a second antenna, wherein the MIMO TRN subfield comprises a first TRN sequence and a second TRN sequence simultaneously transmitted via the first and second antennas, respectively.

43. The apparatus of claim 26 comprising a radio to transmit the packet over the mmWave wireless communication channel, one or more antennas connected to the radio, and a processor to execute instructions of an operating system.

44. A product comprising one or more tangible computer-readable non-transitory storage media comprising instructions operable to, when executed by at least one processor, enable the at least one processor to cause a millimeterWave (mmWave) wireless communication station (STA) to:
transmit a preamble of a packet via a plurality of antennas of the mmWave STA over a mmWave wireless communication channel; and
transmit a Multiple-Input-Multiple-Output (MIMO) Training (TRN) field of the packet over the mmWave wireless communication channel, the MIMO TRN field is after the preamble, the MIMO TRN field comprising a sequence of a plurality of MIMO TRN subfields transmitted via the plurality of antennas of the mmWave STA, wherein a MIMO TRN subfield of the plurality of MIMO TRN subfields comprises a plurality of TRN sequences simultaneously transmitted via the plurality of antennas, respectively.

45. The product of claim 44, wherein the instructions, when executed, cause the mmWave STA to transmit a sequence of a plurality of sector-sweep packets via a respective plurality of antenna sector combinations during a Transmit Sector Sweep (TXSS), wherein transmission of a sector-sweep packet via an antenna sector combination comprises transmission of the preamble of the packet and the MIMO TRN field of the packet via the plurality of antennas according to the antenna sector combination, wherein the antenna sector combination comprises a combination of sectors of the plurality of antennas.
